(19) United States
(12) Patent Application Publication
(10) Pub. No.: US 2017/0113740 A1
(43) Pub. Date: Apr. 27, 2017

(54) Magnetically attached turning vane / vortex generator

(71) Applicant: Juan Carlos Lanza, Miami, FL (US)

(72) Inventor: Juan Carlos Lanza, Miami, FL (US)

(21) Appl. No.: 14/923,698

(22) Filed: Oct. 27, 2015

(51) Int. Cl. B62D 35/00

(52) U.S. Cl. CPC B62D 35/001

(57) ABSTRACT

A generally triangular shaped device with one right angle attached to a magnetic base whose magnetic field strength can range from 100 gauss to 17000 gauss that attaches via magnetic forces to a flat surface. The device is to be positioned so that the leading edge of the device which is the hypotenuse of the right angled triangle faces the flowing medium, with the right angle of the triangle faces away from the flowing medium in which this device will be installed. The device when placed in medium will turn and reorient turbulent low speed flow of the medium into straighten, high speed medium, with a vortex being generated at the tip of the shape. The height of the device being between the 1 to 1.5 times the dimension of the magnetic base.

### BACKGROUND OF THE INVENTION

Most semi-tractor trailer based vehicles have a large aerodynamic drag signature due to the basically cube shape of the cargo container. Various treatments exist for the cube standard configuration but none deal with the issue of various tire and bumper layouts in the rear of the vehicle, all which induce turbulence and increase drag on the vehicle thus causing a reduction in fuel economy. Thus there is no solution the owner/operator of such a vehicle can employee to reduce this type of drag. There is the further issue the trailer portion can be dropped off and changed for another thus representing a different aerodynamic signature.

For other types of semi-tractor trailers such as a flatbed configuration in which the cargo itself is exposed to air at highway speeds, this issue is further compounded as the cargo can be asymmetrical in profile. For example a flatbed tractor trailer fully laden with steel pipe travelling at highway speeds induces a massive drag bubble behind the cargo due to the turbulent wake caused by the temporary structure of the cargo itself, which may not always be the same size and shape. Due to this operating restriction this type of operation has had no aerodynamic solution, or they have been inefficient at addressing these inherent problems.

### BRIEF SUMMARY OF THE INVENTION

My invention resolves these issues outlined, by providing a magnetically attached turning vane/vortex generator, which when positioned properly can significantly reduce drag. All prior art vortex generators/turning vanes had a fixed base which render them immovable and only were effective as long as the structure remained unchanged, thus they never could be of any use to the flatbed scenario herein presented in the background. The advantages of my invention are primarily in the fact that the magnetic base, allows for the owner/operator to customize the installation and orientation of said device to the most optimum aerodynamic package for the given cargo load. The device itself can be mounted directly to the cargo in the case of flatbed trailer, or immediately after to the steel base/frame of the trailer itself, among other surfaces which are suited to be affixed by magnetic means. In the cargo container implementation, the device can be mounted inverted onto the bottom surface of the rear bumper thus straightening, and reducing turbulence from forming as would a turning vane. Additional devices can be mounted behind the rear wheels in an inverted manner at a distance where peak turbulence forms thus further increasing localized airflow, and reducing parasitic drag of the rolling tires. The device can thus be mounted at varying angle and positions so long as it is exposed to flowing medium in the appropriate orientation in relation to the flow.

The added benefits of such a device are in the area of safety. The safety aspect of my invention is twofold, firstly by virtue of a reduced drag wake during rainy conditions the spray pattern behind a tractor trailer/vehicle has been changed and reduced in size, and brought closer to ground level thus increasing visibility for vehicles traveling behind said vehicle with my invention affixed. The second safety aspect of my device is that it can be manufactured using plastics/polymers that would have light luminescent properties during low light/night conditions, this would render the trailer/vehicle more visible at night/during low light conditions as multiple points of light affixed to areas of the vehicle which are usually dark. This would render the vehicle equipped with my invention to be visible from both a greater distance, and during inclement weather conditions thus increasing the overall safety to the road going public of the use of such a device on a land based vehicle.

My invention is also not limited to semi-tractor trailer type vehicles and can be affixed to passenger vehicles, as well as any land based vehicles with a suitable aerodynamic signature. My invention can for example be affixed to a horse trailer rendering the desired aerodynamic affect.

### BRIEF DESCRIPTION OF THE SEVERAL VIEWS OF THE DRAWING

FIG. 1 is a lateral view of the device itself, which features a magnetic base (10) that attached to the mounting surface via magnetic force. The upper structure of the device (30) which mates up to the base (10) at a right angle (20) fulfils its aerodynamic functions.

FIG. 2 is a lateral view of the theoretical positioning of the device attached to the after mentioned cargo tractor trailer.

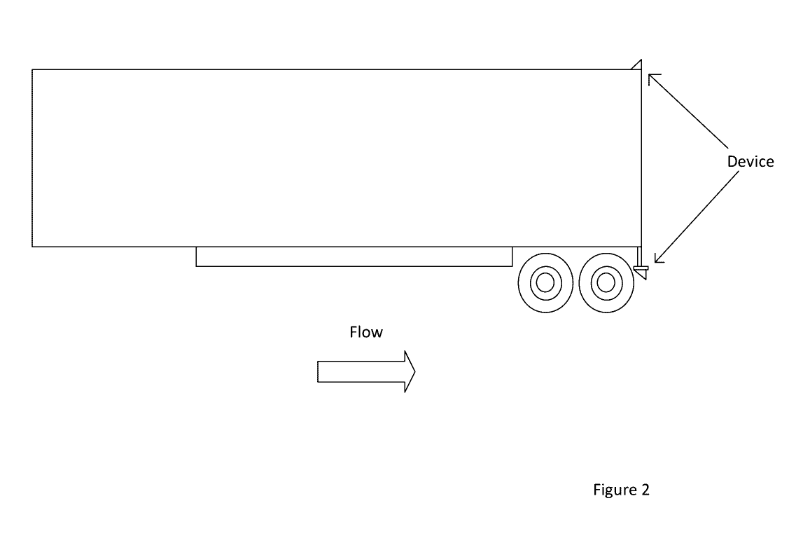

FIG. 3 is a rear view of several of the devices positioned both on the cargo load of the flatbed trailer, as well as attached to the main rear bumper itself of the flatbed trailer.

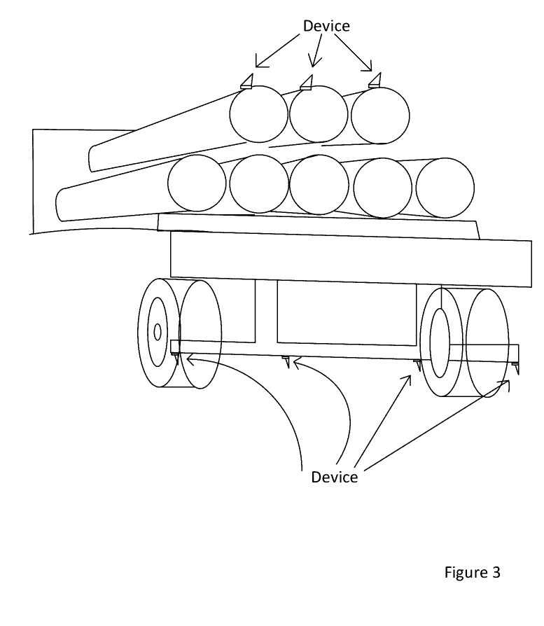

FIG. 4 is a lateral view of the device itself, as can be mounted inverted in the correct position so that the leading edge faces the flowing medium.

FIG. 5 is a frontal view of the device itself, which demonstrates the relative proportions between the magnetic base (10) and the upper structure of the device (20)

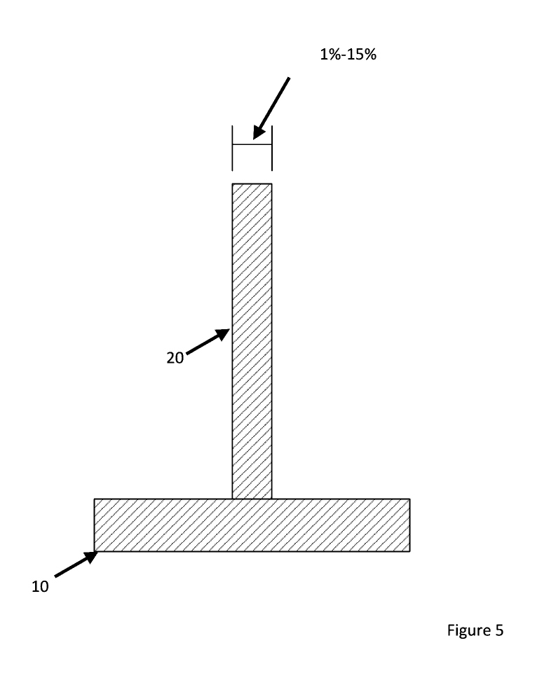

FIG. 6 Shows conceptually the laminar flow layers of the air before and after a typical tractor trailer truck tire, and the corresponding turbulent wake that is generated, as well as the device, and its influence on the flow in the general vicinity.

FIG. 7 Show the effect of the device on the turbulent wake vortex as it interacts with the surface of the device.

FIG. 8 is a top down view of the device with the teardrop shaped magnetic base (10) and upper structure (20) as properly orientated in relation to incoming flowing medium.

FIG. 9 is a basic dimensional reference sheet for the proportions herein referenced. (10) is the overall length of the magnetic base as viewed laterally. This measurement is used in determining the overall height of the upper structure (20) which will be in the range specified in the claims. The width of the magnetic base (30) as viewed from above will be the measurement used to determine the upper structure width (40) as specified in the claims.

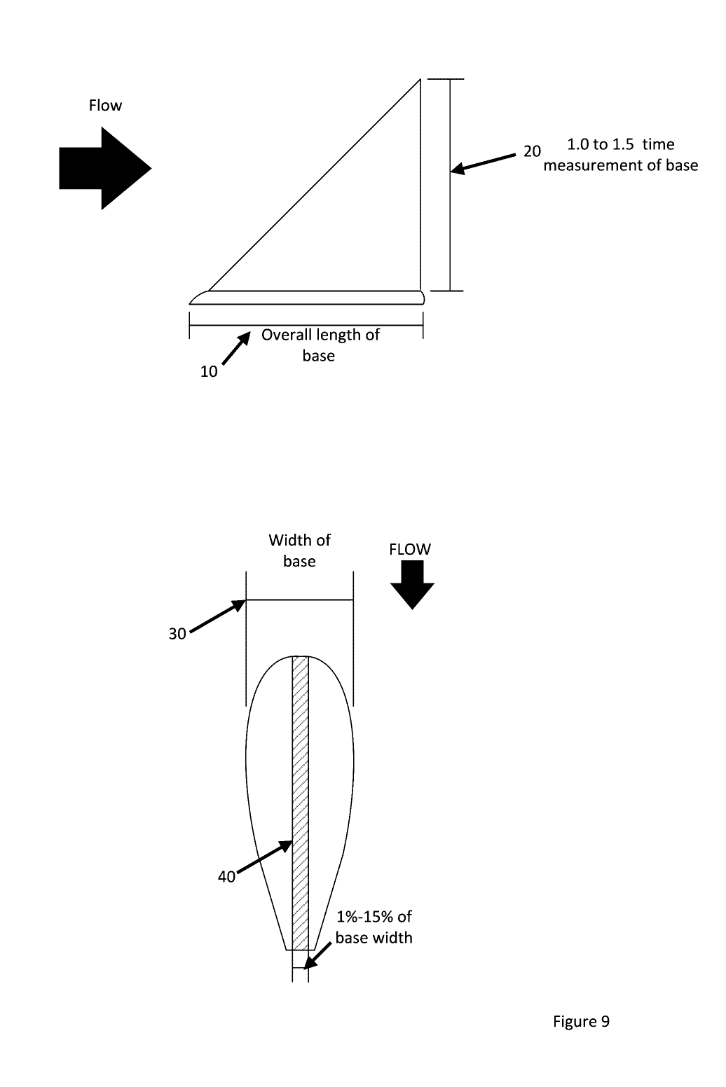

### DETAILED DESCRIPTION OF THE INVENTION

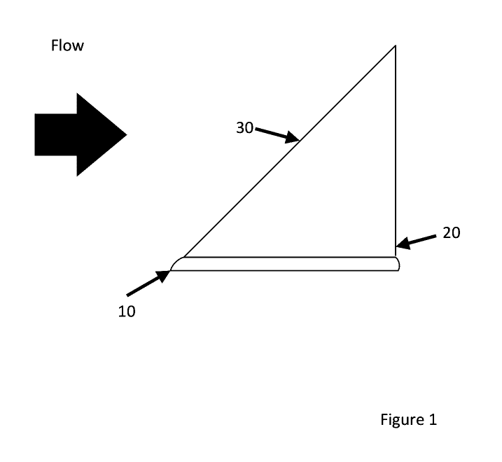

The device in FIG. 1 with reference number (10) is the magnetic base whose magnetic field strength can range from 100 gauss to 17000 gauss that attaches via magnetic forces to a flat surface.

Reference number (20) in FIG. 1 is the right angle formed by bonding by various methods of the aerodynamic structure to the magnetic base reference (10). Reference number (30) in FIG. 1 is the leading edge of the structure whose overall cross-sectional thickness can be in the range of 1%-15% the width of the magnetic base of (10).

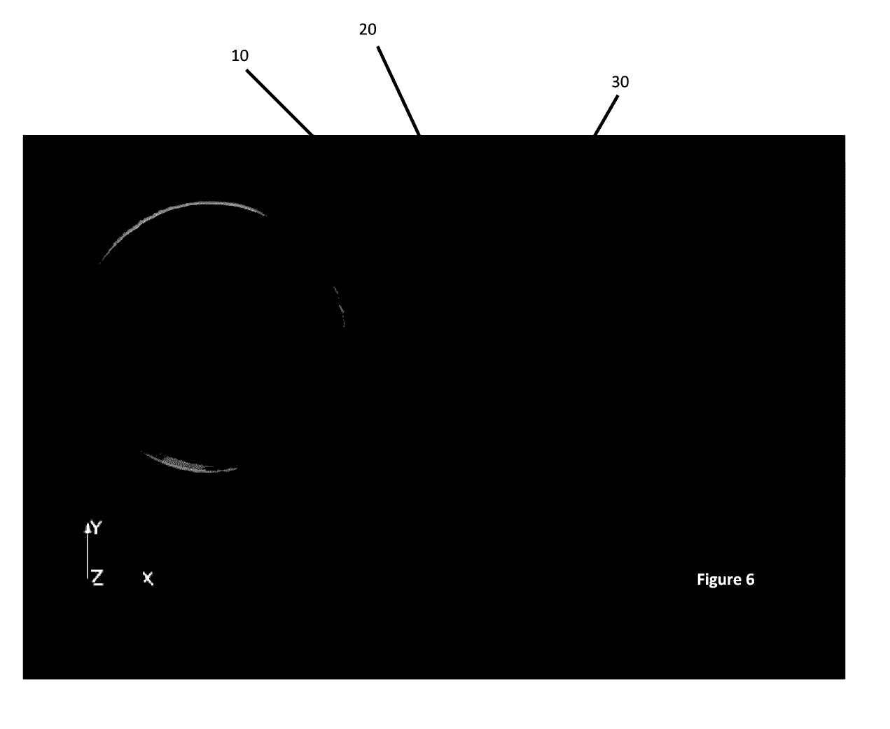

FIG. 6 depicts a typical flow pattern for a tractor truck trailer traveling at highway speeds as simulated using Computational Fluid Dynamic herein referred to as (CFD). Please note the naturally occurring phenomena of a turbulent wake after the tire such as the surface tension clinging of flow medium (10), with a turbulent low speed medium vortices trailing off (20). The device (30) is in the flowing medium and properly oriented with its leading edge facing towards the flow.

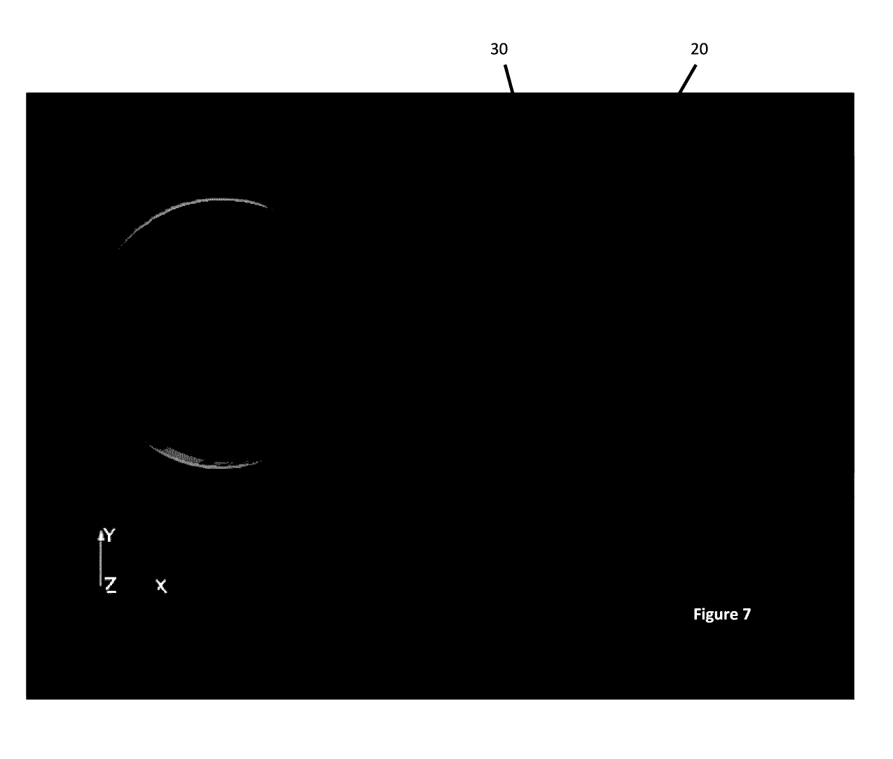

FIG. 7 depicts a typical flow pattern for a tractor truck trailer traveling at highway speeds as simulated using (CFD), with the turbulence now interacting (20) and being re-energized (20) and redirected upon contact with the device (30). This can be seen in the drawing as both a change in shape, and size of the CFD turbulence wake as it dissipates due to the interaction with the device (30)

1. The Device in FIG. 1 whose base (10) attached to a flat surface via magnetic force properties, and whose structure (30) predominately will be in the flowing medium. Once positioned and flow applied the device reference FIG. 6 (30) will produce the effect of straightening, and increasing flow speed in the general area aft of the device in relations to the speed of the turbulent incoming medium reference FIG. 6 (10) and (20).
a. Turbulent flowing medium reference FIG. 6 (20) is reenergized and straightened thus reducing drag on the object which the device is attached to reference attached FIG. 7 (20) note vortex is destroyed due to re-energization of the medium.

2. The device in claim 1 has for its magnetic attached base FIG. 1 (10) a magnetic field strength measured in Gauss of between 100 gauss to 170000 gauss.

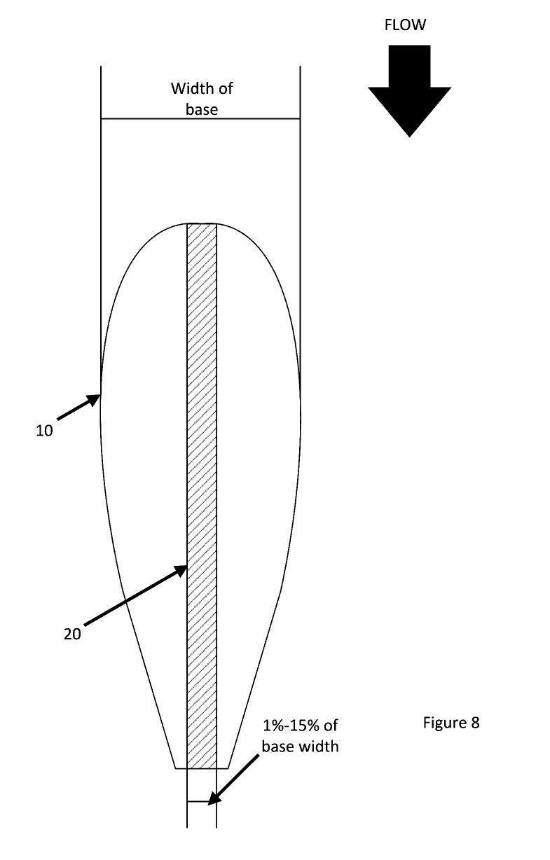

3. The device in claim 1 will further have the magnetic base from claim 2 to be generally teardrop in shape reference FIG. 8 (10) with the leading edge of the upper structure FIG. 8 (20) facing the flowing medium.

4. The device upper triangular structure will have a height of between 1 to 1.5 times the base in claim 2.

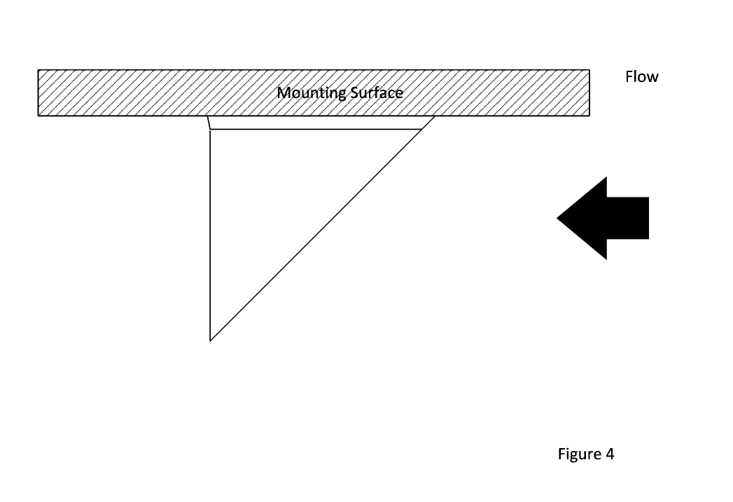

5. The width of the upper structure will be between of 1%-15% the base in claim 2.
The device in claim 1 can be mounted upside down with the tip of the structure pointed downward so long as the leading edge faces the flowing medium (see FIG. 4 drawing)
